(19) United States
(12) Patent Application Publication
(10) Pub. No.: US 2017/0287616 A1
(43) Pub. Date: Oct. 5, 2017

(54) MAGNETIC ELEMENT

(71) Applicant: FSP TECHNOLOGY INC., Taoyuan (TW)

(72) Inventors: Kuo-Fan Lin, Taoyuan (TW); Fu-Kai Tu, Taoyuan (TW)

(21) Appl. No.: 15/464,263

(22) Filed: Mar. 20, 2017

Related U.S. Application Data
(60) Provisional application No. 62/315,677, filed on Mar. 31, 2016.

(30) Foreign Application Priority Data
Oct. 13, 2016 (TW) 105132959

(51) Int. Cl. H01F 27/24; H02M 1/42; H01F 27/28

(52) U.S. Cl. CPC H01F 27/24; H01F 27/2823; H02M 1/42

(57) ABSTRACT

A magnetic element of the present invention includes a magnetic core member and a winding. The magnetic core member includes a central post, at least one lateral post and a winding space, and the winding is disposed in the winding space and around the central post. The central post includes a plurality of central air gaps, and the at least one lateral post includes a plurality of lateral air gaps.

### FIELD OF THE INVENTION

The present invention relates to a magnetic element, and more particularly to a magnetic element forming a plurality of air gaps on a magnetic path thereof.

### BACKGROUND OF THE INVENTION

Referring to FIGS. 1A and 1B, conventional magnetic elements, such as transformers or inductance elements, include a first magnetic core 11 and a second magnetic core 12. The first magnetic core 11 has a central post 111, and the second magnetic core has a central post 121. A single air gap 14 is formed between the central post 111 and the central post 121 to prevent magnetic saturation. However, when such a single air gap 14 is larger, higher magnetic leakage may occur and thus increase energy loss. In addition, a winding 13 is fixed between the first magnetic core 11 and the second magnetic core 12 through a winding frame 10. The winding frame 10 occupies a considerable space and thus reduces the total number of windings between the first magnetic core 11 and the second magnetic core 12 so that utilization ratio of the winding and working efficiency of the magnetic element are reduced. Another conventional magnetic element includes several air gaps formed on a central post is seen in the market. The multiple air gaps can reduce and disperse magnetic leakage loss and therefore decrease magnetic flux diffusion. However, the central post limits the amount and distribution of the air gaps. When the number of the air gaps in the central post is increased, a distance between two adjacent air gaps is reduced. When the distance between two adjacent air gaps is less than a critical value, the magnetic flux diffusion cannot be further effectively reduced, and the improvement for the working efficiency is therefore limited.

### SUMMARY OF THE INVENTION

The present invention provides a magnetic element including a central post and a lateral post connected to the central post, and a plurality of air gaps are formed in the central post and the lateral post. The air gaps are uniformly distributed in a magnetic path formed in the central post and the lateral post rather than concentrated in the central post, which further effectively reduces the magnetic flux diffusion and also prevents the magnetic saturation and controls the magnetic leakage loss in a desired range.

An embodiment of the magnetic element of the present invention includes a magnetic core member and a winding. The magnetic core member includes a central post, at least one lateral post and a winding space, and the winding is disposed in the winding space and around the central post. The central post includes a plurality of central air gaps, and the at least one lateral post includes a plurality of lateral air gaps.

In another embodiment, the magnetic core member includes a first magnetic core and a second magnetic core, the first magnetic core comprises a first central post and at least one first lateral post, and the second magnetic core comprises a second central post corresponding to the first central post and at least one second lateral post corresponding to the at least one first lateral post, wherein the first magnetic core is coupled to the second magnetic core to form the winding space, the central post comprises the first central post and the second central post, and the at least one lateral post comprises at least one first lateral post and at least one second lateral post, the central air gap comprises a first air gap formed in the first central post and a third air gap formed in the second central post, and the lateral air gap comprises a second air gap formed in the first lateral post and a fourth air gap formed in the second lateral post.

In another embodiment, an adhesive is filled and sintered in the first air gap, the second air gap, the third air gap and the fourth air gap, and the adhesive is a Bond-Ply material.

In another embodiment, a position of the first air gap corresponds to a position of the second air gap, and a position of the third air gap corresponds to a position of the fourth air gap.

In another embodiment, a cross sectional area of the first lateral post is half of a cross sectional area of the first central post, and a cross sectional area of the second lateral post is half of a cross sectional area of the second central post.

In another embodiment, the first magnetic core comprises the two of the first lateral posts, the second magnetic core comprises two of the second lateral posts, and the first magnetic core and the second magnetic core form a first magnetic path comprising the first air gap, two of the second air gaps, two of the fourth air gaps, and the third air gap.

In another embodiment, an equivalent air gap of the first magnetic path is equivalent to four of the serially arranged central air gaps.

In another embodiment, a fifth air gap is formed between the first central post of the first magnetic core and the second central post of the second magnetic core, and a sixth air gap is formed between the first lateral post of the first magnetic core and the second lateral post of the second magnetic core.

In another embodiment, the first magnetic core comprises two of the first lateral posts, the second magnetic core comprises two of the second lateral posts, and the first magnetic core and the second magnetic core form a second magnetic path comprising the first air gap, two of the second air gaps, two of the sixth air gaps, two of the fourth air gaps, the third air gap and the fifth air gap, and the second magnetic path has an equivalent air gap equivalent to six of the serially arranged central air gaps.

In another embodiment, an adhesive is filled and sintered in the first air gap, the second air gaps, the third air gap, the fourth air gaps, the fifth air gap and the sixth air gaps, and the adhesive is a Bond-Ply material.

In another embodiment, the magnetic element further includes an isolating member externally spaced from the lateral post for a predetermined distance.

In another embodiment, the isolating member is made of magneto-conductive materials.

In another embodiment, the isolating member covers the lateral air gap completely.

In another embodiment, the winding comprises coils winded by electro-conductive flat wires.

In another embodiment, the magnetic element is applied to a transformer of a fly back converter, an output inductance element of a forward converter or an inductance element of a power factor correction circuit of a power supply.

The present invention provides another embodiment of the magnetic element. The magnetic element includes a magnetic core member, a winding and at least one isolating member. The magnetic core member includes a central post, at least one lateral post and a winding space. The winding is disposed in the winding space and around the central post. The isolating member is externally spaced from the at least one lateral post for a predetermined distance, wherein a plurality of air gaps are formed in the lateral post.

In another embodiment, the isolating member is made of magneto-conductive materials.

In another embodiment, the winding is directly positioned on the central post.

In another embodiment, an adhesive is filled and sintered in the air gaps, and the adhesive is a Bond-Ply material.

In another embodiment, the winding comprises coils winded by electro-conductive flat wires.

In another embodiment, the isolating member covers the air gaps completely.

In another embodiment, the magnetic core member comprises a first magnetic core and a second magnetic core, the first magnetic core comprises a first central post and at least one first lateral post, and the second magnetic core comprises a second central post corresponding to the first central post and at least one second lateral post corresponding to the at least one first lateral post, wherein the first magnetic core is coupled to the second magnetic core to form the winding space, the central post comprises the first central post and the second central post, and the at least one lateral post comprises the at least one first lateral post and the at least one second lateral post, the first lateral post comprises a seventh air gap and the second lateral post comprises an eighth air gap.

In another embodiment, a ninth air gap is formed between the first lateral post and the second lateral post.

In another embodiment, the magnetic element is applied to a transformer of a fly back converter, an output inductance element of a forward converter or an inductance element of a power factor correction circuit of a power supply.

Since the magnetic element of the present invention includes several air gaps formed in the central post and the lateral posts and distributed uniformly on the entire magnetic path, such a structure prevents magnetic saturation and controls the magnetic leakage loss in a desired range. In addition, the magnetic element of the present invention further includes the isolating member disposed externally to the lateral posts to conduct the leaked magnetic flux back to the isolating member so as to reduce magnetic leakage and loss. In addition, since the winding of the magnetic element of the present invention is directly disposed on the central post without a winding frame, the number of windings is thus increased so as to improve utilization ratio of the winding and working efficiency of the magnetic element.

### BRIEF DESCRIPTION OF THE DRAWINGS

The present invention will become more readily apparent to those ordinarily skilled in the art after reviewing the following detailed description and accompanying drawings, in which:

FIG. 1A is a perspective exploded view of a conventional inductance element;

FIG. 1B is a perspective view of a magnetic core of a conventional inductance element;

FIG. 2A is a perspective exploded view of an embodiment of a magnetic element of the present invention;

FIG. 2B is a perspective view of the magnetic element of FIG. 2A;

FIG. 3A is a cross section of a magnetic core of FIGS. 2A and 2B;

FIG. 3B is a cross section of another embodiment of a magnetic element of the present invention;

FIG. 3C is a schematic view of a magnetic path in the magnetic core of FIG. 3A;

FIG. 3D is a schematic view of a magnetic path in the magnetic core of FIG. 3B;

FIG. 4A is a perspective exploded view of another embodiment of a magnetic element of the present invention;

FIG. 4B is a perspective view of the magnetic element of FIG. 4A;

FIG. 4C is a cross section of a magnetic core of FIGS. 4A and 4B;

FIG. 5A is a schematic view of a magnetic element of the present invention applied to a fly back converter; and

FIG. 5B is a schematic view of a magnetic element of the present invention applied to a forward converter.

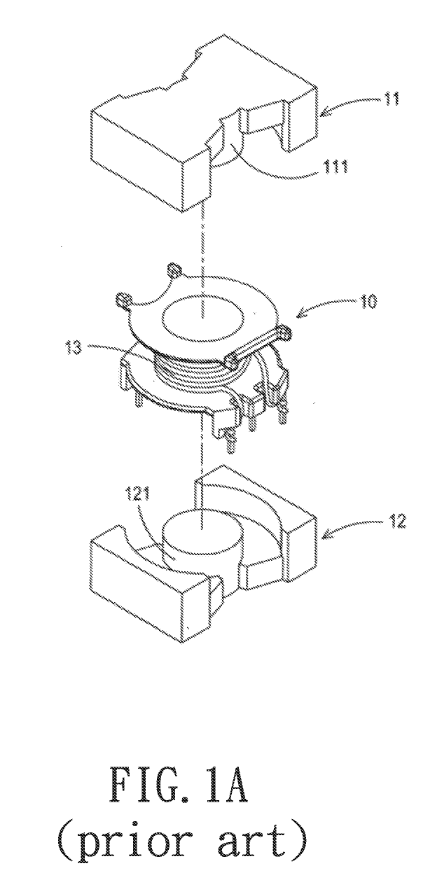

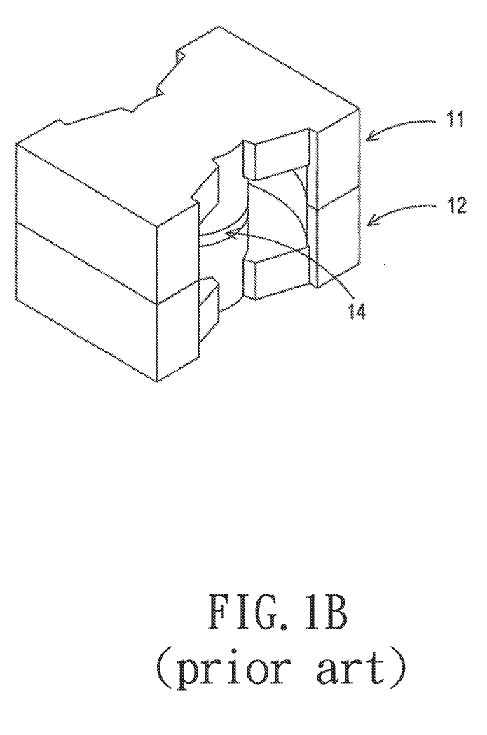

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

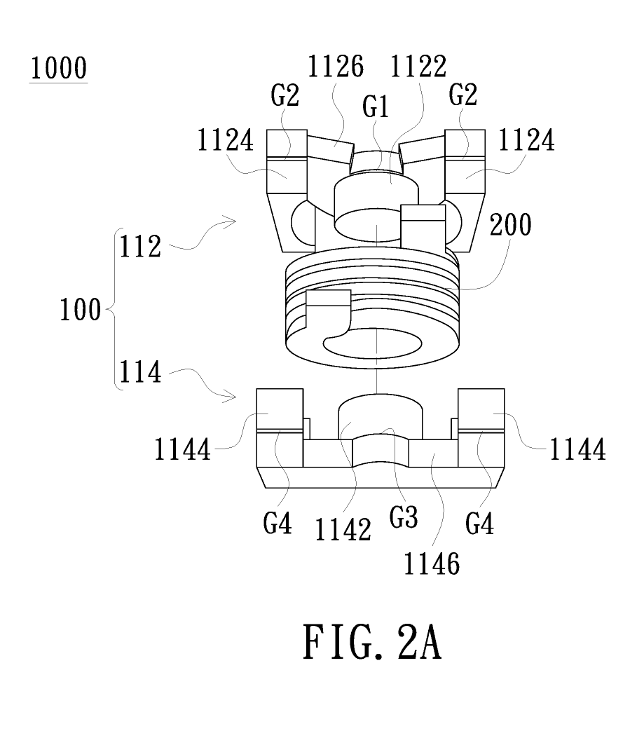

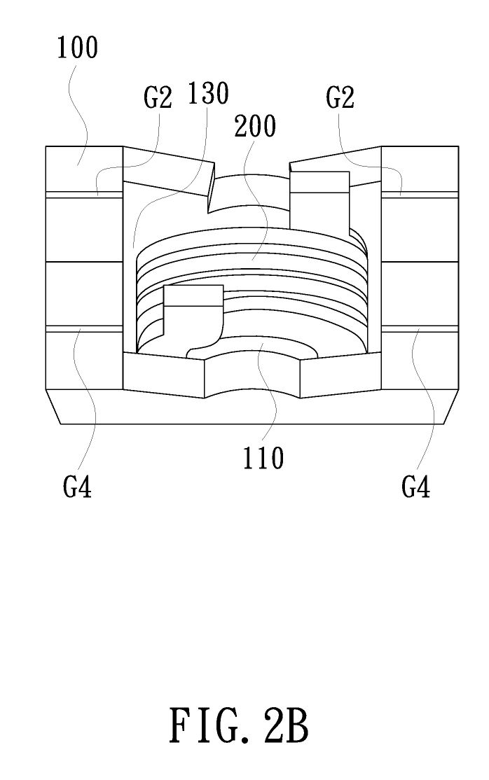

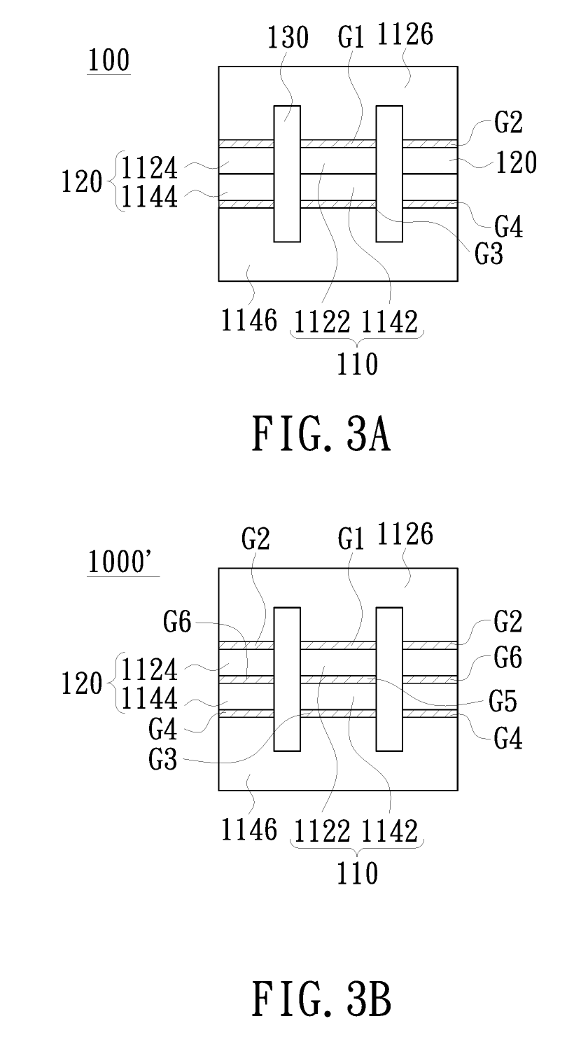

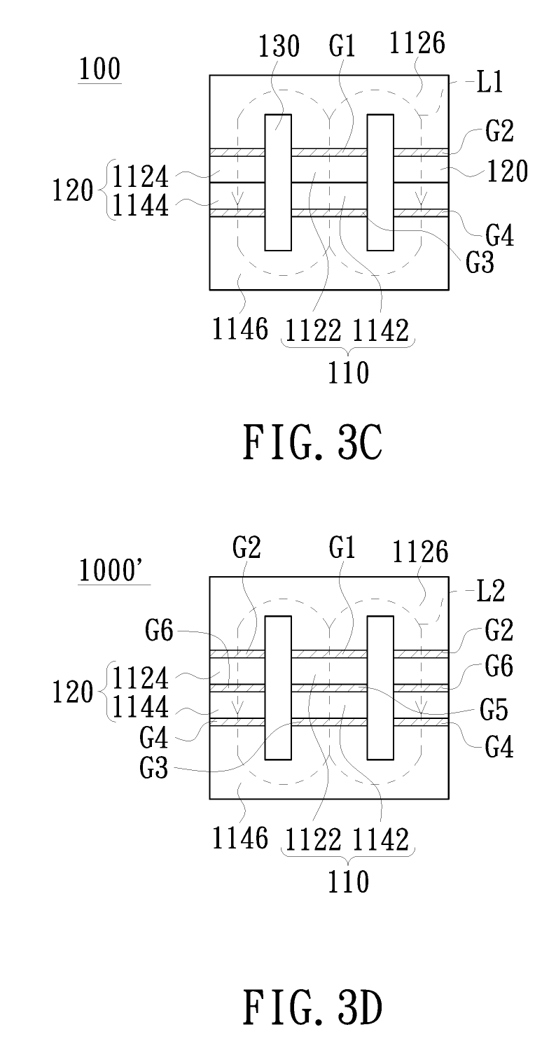

Referring to FIGS. 2A, 2B and 3A, an embodiment of a magnetic element 1000 of the present invention includes a magnetic core member 100 and a winding 200. As shown in FIG. 3A, the magnetic core member 100 includes a central post 110, two lateral posts 120 and a winding space 130. As shown in FIG. 2B, the winding 200 is disposed in the winding space 130 and around the central post 110. Two central air gaps G1 and G3 are formed in the central post 110, and two lateral air gaps G2 and G4 are formed in each of the lateral posts 120. The magnetic core member 100 is made of magneto-conductive materials.

As shown in FIG. 3A, in this embodiment, the magnetic core member 100 includes a first magnetic core 112 and a second magnetic core 114 connected to and aligned with the first magnetic core 111. The first magnetic core 112 includes a first central post 1122 and two first lateral posts 1124. The first magnetic core 112 further includes a first connecting portion 1126 through which the first central post 1122 is connected to the first lateral posts 1124, whereby the first magnetic core 112 is thus W-shaped. The first lateral post 1124 has a cross sectional area which is half a cross sectional area of the first central post 1122. The second magnetic core 114 includes a second central post 1142 corresponding to the first central post 1122 and two second lateral posts 1144 corresponding to the first lateral posts 1124. The second magnetic core 114 further includes a second connecting portion 1146 through which the second central post 1142 is connected to the second lateral posts 1144, whereby the second magnetic core 114 is thus W-shaped. The second lateral post 1144 has a cross sectional area which is half a cross sectional area of the second central post 1142.

The first magnetic core 112 is combined with the second magnetic core 114 face to face to form the magnetic core member 100 and the winding space 130 within the magnetic core member 100. The combination of the first magnetic core 112 and the second magnetic core 114 is accomplished by adhesives. Similarly, the first central post 1122 is combined with the second central post 1142 to form the central post 110. The two first lateral posts 1124 are combined to the two second lateral posts 1144 to from the two lateral posts 120. A first air gap G1 is formed in the first central post 1122, a second air gap G2 (a seventh air gap) is formed in the first lateral post 1124. A third air gap G3 is formed in the second central post 1142, and a fourth air gap G4 (an eighth air gap) is formed in the second lateral post 1144. The central air gaps include the first air gap G1 formed in the first central post 1122 and the third air gap G3 formed in the second central post 1142. The lateral air gaps include the second air gaps G2 formed in the first lateral posts 1124 and the fourth air gaps G4 formed in the second lateral posts 1144. In this embodiment, an adhesive is filled and sintered in the first air gap G1, the second air gap G2, the third air gap G3 and the fourth air gap G4, and the adhesive is a Bond-Ply material. The Bond-Ply material has both stickiness and isolation properties and has a larger hardness after it is sintered (heated) so as to form a predetermined air gap width. A position of the first air gap G1 corresponds to a position of the second air gap G2, and a position of the third air gap G3 corresponds to a position of the fourth air gap G4. In this embodiment, the position of the first air gap G1 is aligned with the position of the second air gap G2, and the position of the third air gap G3 is aligned with the position of the fourth air gap G4. Although the magnetic core member 100 is formed by the combination of the first magnetic core 112 and the second magnetic core 114, the magnetic core member 100 of the present invention is not limited thereto. In another embodiment, the magnetic core member of the present invention can be formed by combination of more than two magnetic cores.

Referring again to FIGS. 2A and 2B, the winding 200 is directly disposed around the central post 110 and positioned in the winding space 130. In this embodiment, the winding 200 is formed by boils winded by flat wires having a width larger than its thickness. The winding 200 formed by such a flat wire has a DC resistance smaller than that of an ordinary winding formed by a wire having a width substantially equal to its thickness, such as a pie-shaped coil of multiple twisted wires, but has an AC resistance similar to that of the ordinary winding. Therefore, the total loss in the winding 200 of flat wires is less than that in the ordinary winding. When current flows in the winding 200, a magnetic field is created by the winding 200 due to electromagnetic effect. As the winding 200 is mounted to the central post 110 and the magnetic core member 100 is made of magneto-conductive materials, a magnetic flux generated by the winding 200 is conducted in the magnetic core member 100, forming a first magnetic path L1 as shown in FIG. 3C. The first magnetic path L1 includes the first air gap G1, the two second air gaps G2, the third air gap G3 and the two fourth air gaps G4. Therefore, the first magnetic path L1 includes two central air gaps (the first air gap G1 and the third air gap G3) and four lateral air gaps (the two second air gaps G2 and the two fourth air gaps G4). Since the cross sectional area of the central post 110 is twice the cross sectional area of the lateral post 120, the equivalent air gap of the first magnetic path L1 is obtained by adding a product of the amount of the central air gap multiplied by a weighting coefficient 1 to a product of the amount of the lateral air gap multiplied by a weighting coefficient ½. That is the equivalent air gap of the first magnetic path L1 is 2×1+4×(½)=4. The equivalent air gap of the first magnetic path L1 is equivalent to four serially arranged central air gaps.

Referring to FIGS. 3B and 3D, another embodiment of a magnetic element of the present invention is disclosed. A magnetic element 1000′ in this embodiment has a structure similar to the magnetic element 1000 shown in FIGS. 2A and 2B. The same elements of the two embodiments are given the same numerical, and the descriptions for them are thus omitted. In this embodiment, the first magnetic core 112 is spaced from the second magnetic core 114 for a distance, whereby a fifth air gap G5 is formed between the first central post 1122 and the second central post 1142, and a sixth air gap G6 (ninth air gap) is formed between the first lateral post 1124 and the second lateral post 1144. Similarly, an adhesive is also filled and sintered in the fifth air gap G5 and sixth air gap G6. The adhesive is a Bond-Ply material having both stickiness and isolation properties and having larger hardness after it is sintered (heated) so as to form a predetermined air gap width. In this embodiment, a second magnetic path L2 is formed in the magnetic element 1000′. The second magnetic path L2 includes the first air gap G1, the two second air gaps G2, the third air gap G3, the two fourth air gaps G4, the fifth air gap G5 and the two sixth air gaps G6. The second magnetic path L2 includes three central air gaps (the first air gap G1, the third air gap G3 and the fifth air gap G5) and six lateral air gaps (two second air gaps G2, two fourth air gaps G4 and two sixth air gaps G6). The equivalent air gap of the second magnetic path L2 is 3×1+6×(½)=6. That is the equivalent air gap of the second magnetic path L2 is equivalent to six serially arranged central air gaps.

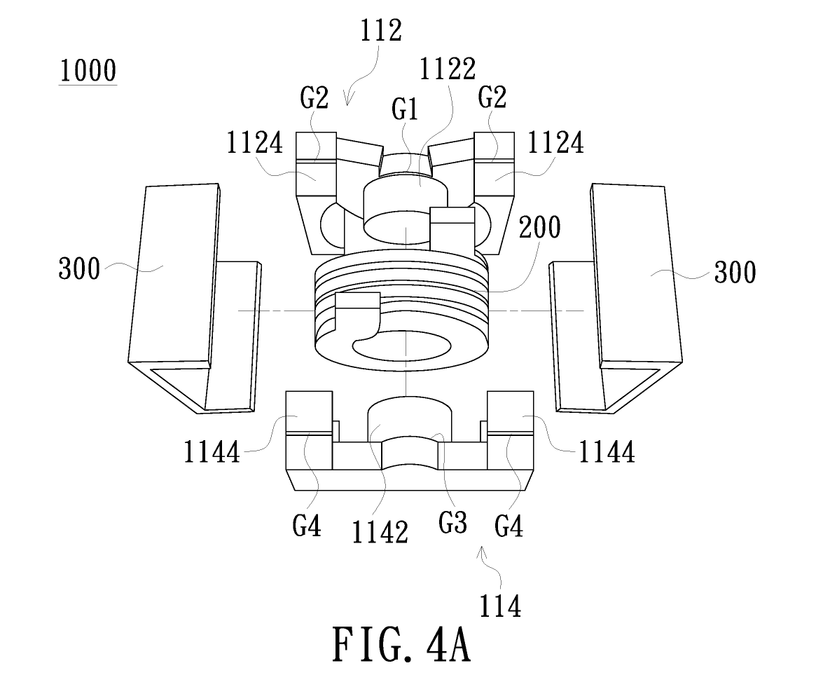

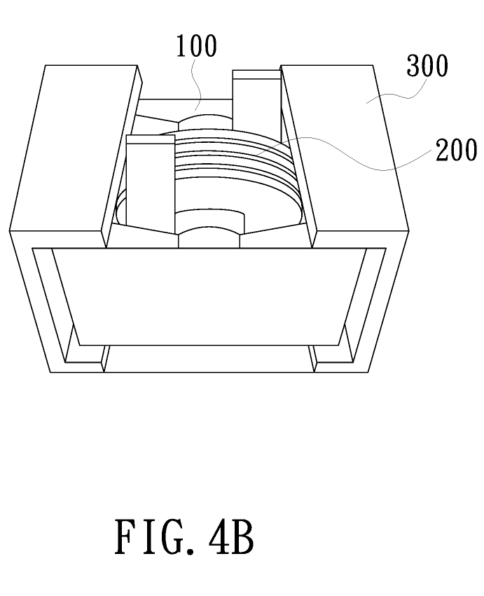

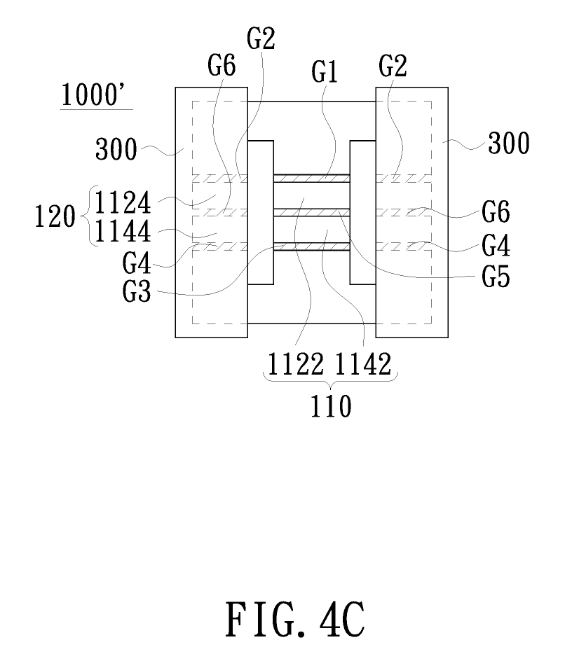

Referring to FIGS. 4A, 4B and 4C, the magnetic element 1000 further includes an isolating member 300 disposed externally to the lateral post 120 and covers the lateral air gaps. The isolating member 300 is made of magneto-conductive materials. In this embodiment, the isolating member 300 is made of a material identical to that of the magnetic core member 100. The isolating member 300 is external to the lateral post 120 and the magnetic flux leaked from the lateral air gaps G2, G4 and G6 is conducted by the isolating member 300, whereby the magnetic flux is isolated and thus converges through the isolating member 300 so as to reduce eddy current loss caused by the leaked magnetic flux on a metal housing of a device or other metal elements and increase efficiency of the magnetic core member 100. The isolating member 300 of FIG. 2B is U-shaped covering a lateral side of the lateral post 120 as well as its front side and rear side so as to cover the lateral post 120 completely. In another embodiment, the isolating member 300 is C-shaped. In addition, since the isolating member 300 is made of magneto-conductive materials, the isolating member 300 is spaced from the lateral post 120 for a predetermined distance. If the isolating member 300 contacts the lateral post 120, the magnetic flux will flow directly through the isolating member 300 having a magnetic resistance less than the lateral post 120 rather than flows through the lateral post 120.

In another embodiment, the magnetic core member 100 includes a first air gap G1 formed in the first central post 1122, a second air gap G2 formed in the second central post 1124, a fifth air gap G5 formed between the first central post 1122 and the second central post 1142 and two sixth air gaps G6 formed between the first lateral posts 1124 and the second lateral posts 1144. However, no air gap is formed in the second central post 1142 and the second lateral posts 1144. The equivalent air gap of a magnetic path formed in the magnetic core member 100 is also equivalent to four serially arranged central air gaps similar to the calculation of the equivalent air gap for the embodiment of FIGS. 2A and 2B.

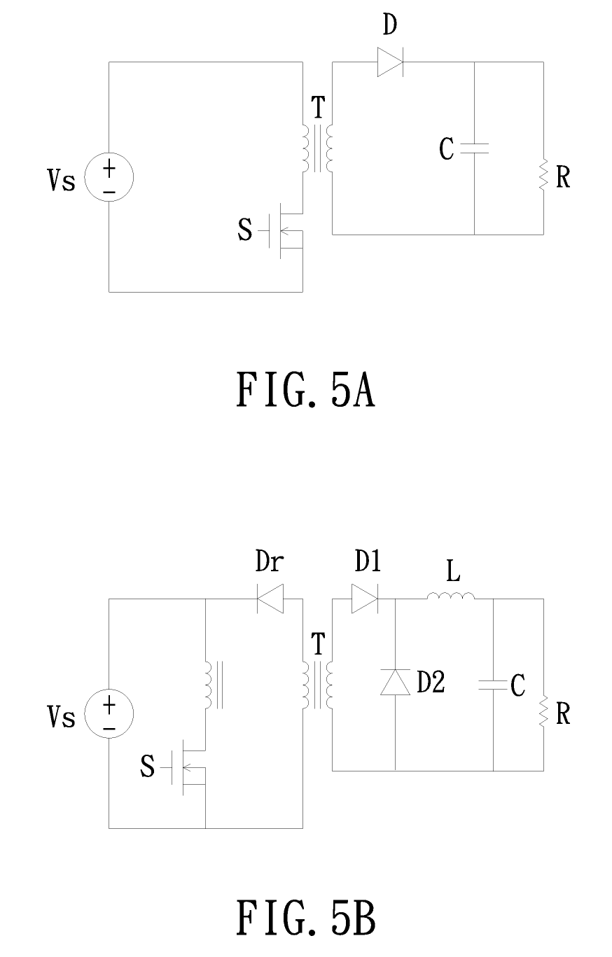

The magnetic element 1000 and 1000′ as shown in FIGS. 5A and 5B can be applied to a transformer T of a fly back converter, an output inductance L of a forward converter or an inductance element of a power factor correction circuit of a power supply to promote transfer efficiency of circuits.

Since the magnetic element of the present invention includes several air gaps formed in the central post and the lateral posts and distributed uniformly on the entire magnetic path, such a structure prevents magnetic saturation and controls the magnetic leakage loss in a desired range. In addition, the magnetic element of the present invention further includes the isolating member disposed externally to the lateral posts to conduct the leaked magnetic flux back to the isolating member so as to reduce magnetic leakage and loss. In addition, since the winding of the magnetic element of the present invention is directly disposed on the central post without a winding frame, the number of windings is thus increased so as to improve utilization ratio of the winding and working efficiency of the magnetic element.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic element, comprising:
a magnetic core member comprising a central post, at least one lateral post and a winding space; and
a winding disposed in the winding space and around the central post, wherein the central post comprises a plurality of central air gaps, and the at least one lateral post comprises a plurality of lateral air gaps.

2. The magnetic element according to claim 1, wherein the magnetic core member comprises a first magnetic core and a second magnetic core, the first magnetic core comprises a first central post and at least one first lateral post, and the second magnetic core comprises a second central post corresponding to the first central post and at least one second lateral post corresponding to the at least one first lateral post, wherein the first magnetic core is coupled to the second magnetic core to form the winding space, the central post comprises the first central post and the second central post, and the at least one lateral post comprises the at least one first lateral post and the at least one second lateral post, the central air gaps comprise a first air gap formed in the first central post and a third air gap formed in the second central post, and the lateral air gaps comprise a second air gap formed in the first lateral post and a fourth air gap formed in the second lateral post.

3. The magnetic element according to claim 2, wherein an adhesive is filled and sintered in the first air gap, the second air gap, the third air gap and the fourth air gap, and the adhesive is a Bond-Ply material.

4. The magnetic element according to claim 2, wherein a position of the first air gap corresponds to a position of the second air gap, and a position of the third air gap corresponds to a position of the fourth air gap.

5. The magnetic element according to claim 2, wherein a cross sectional area of the first lateral post is half of a cross sectional area of the first central post, and a cross sectional area of the second lateral post is half of a cross sectional area of the second central post.

6. The magnetic element according to claim 5, wherein the first magnetic core comprises two of the first lateral posts, the second magnetic core comprises two of the second lateral posts, and the first magnetic core and the second magnetic core form a first magnetic path comprising the first air gap, two of the second air gaps, two of the fourth air gaps, and the third air gap.

7. The magnetic element according to claim 6, wherein an equivalent air gap of the first magnetic path is equivalent to four of the serially arranged central air gaps.

8. The magnetic element according to claim 2, wherein a fifth air gap is formed between the first central post of the first magnetic core and the second central post of the second magnetic core, and a sixth air gap is formed between the first lateral post of the first magnetic core and the second lateral post of the second magnetic core.

9. The magnetic element according to claim 8, wherein the first magnetic core comprises two of the first lateral posts, the second magnetic core comprises two of the second lateral posts, and the first magnetic core and the second magnetic core form a second magnetic path comprising the first air gap, two of the second air gaps, two of the sixth air gaps, two of the fourth air gaps, the third air gap and the fifth air gap, and the second magnetic path has an equivalent air gap equivalent to six of the serially arranged central air gaps.

10. The magnetic element according to claim 8, wherein an adhesive is filled and sintered in the first air gap, the second air gaps, the third air gap, the fourth air gaps, the fifth air gap and the sixth air gaps, and the adhesive is a Bond-Ply material.

11. The magnetic element according to claim 1, further comprising an isolating member externally spaced from the lateral post for a predetermined distance.

12. The magnetic element according to claim 11, wherein the isolating member is made of magneto-conductive materials.

13. The magnetic element according to claim 11, wherein the isolating member covers the lateral air gap completely.

14. The magnetic element according to claim 1, wherein the winding comprises coils winded by electro-conductive flat wires.

15. The magnetic element according to claim 1, wherein the magnetic element is applied to a transformer of a fly back converter, an output inductance element of a forward converter or an inductance element of a power factor correction circuit of a power supply.

16. A magnetic element, comprising:
a magnetic core member comprising a central post, at least one lateral post and a winding space;
a winding disposed in the winding space and around the central post; and
at least one isolating member externally spaced from the at least one lateral post for a predetermined distance, wherein a plurality of air gaps are formed in the lateral post.

17. The magnetic element according to claim 16, wherein the isolating member is made of magneto-conductive materials.

18. The magnetic element according to claim 16, wherein the winding is directly positioned on the central post.

19. The magnetic element according to claim 16, wherein an adhesive is filled and sintered in the air gaps, and the adhesive is a Bond-Ply material.

20. The magnetic element according to claim 16, wherein the winding comprises coils winded by electro-conductive flat wires.

21. The magnetic element according to claim 16, wherein the isolating member covers the air gaps completely.

22. The magnetic element according to claim 16, wherein the magnetic core member comprises a first magnetic core and a second magnetic core, the first magnetic core comprises a first central post and at least one first lateral post, and the second magnetic core comprises a second central post corresponding to the first central post and at least one second lateral post corresponding to the at least one first lateral post, wherein the first magnetic core is coupled to the second magnetic core to form the winding space, the central post comprises the first central post and the second central post, and the at least one lateral post comprises the at least one first lateral post and the at least one second lateral post, the first lateral post comprises a seventh air gap and the second lateral post comprises an eighth air gap.

23. The magnetic element according to claim 22, wherein a ninth air gap is formed between the first lateral post and the second lateral post.

24. The magnetic element according to claim 16, wherein the magnetic element is applied to a transformer of a fly back converter, an output inductance element of a forward converter or an inductance element of a power factor correction circuit of a power supply.
